(19) United States
(12) Patent Application Publication
(10) Pub. No.: US 2009/0033067 A1
(43) Pub. Date: Feb. 5, 2009

(54) AIRPORT LUGGAGE TROLLEY WITH A BUILT-IN PERSONAL COMPUTER

(76) Inventors: Marcelo Machado Coelho, Goiania-Go (BR); Jose Roberto da Paixao Jr., Goiania-Go (BR)

Correspondence Address: FURR LAW FIRM, 2622 DEBOLT ROAD, UTICA, OH, 43080, US

(21) Appl. No.: 12/159,626

(22) PCT Filed: Dec. 21, 2006
(86) PCT No.: PCT/BR2006/000310

§ 371 Date: Jun. 29, 2008

(30) Foreign Application Priority Data
Dec. 29, 2005 (BR) PI-05062268

(51) Int. Cl. B62B 3/00

(52) U.S. Cl. 280/651

(57) ABSTRACT

The present invention is understood by one Trolley with a built-in personal computer, with monitor and folding keyboard with all the functions and mouse for internet access and other computer services while passengers wait for flights in airports lobbies and attached on the luggage Trolley (1) will be built sustentation bars (8) on which will be fixed a inferior compartment (3) to hold a computer CPU and battery. On the inferior luggage Basket (2) will be installed a superior compartment (5) to hold a keyboard (4) and on the back of the referred luggage Basket will be installed a monitor (6), in a way the inferior compartment (3) will offer space as well on the back or front for advertising, witch is propaganda (9) and the referred inferior compartment (3) will also have a female connector (10) to receive cell phone chargers.

Refers the present invention to an airport luggage Trolley with a built-in personal computer, with folded monitor and keyboard for visualization and typing and mouse functions, in way to make possible the access to the internet and other related computer activities, while a passenger waits for his flight in airport lobbies.

There are many available ways to hourly pay for internet connection in computers installed in specialized business places like “LAN Houses”, and even in computer booths placed at public places as for instance, in airports, however, it is no known any other that provides this device easiness, that can freely circulate inside large rooms, excluding private notebooks with their owners. Up to this day is not known any personal computer rental that is able to freely circulate in public places due to inherent risks of this activity in certain places or situations, making it an unviable service; on another side, the airports luggage trolleys carries the luggage, however they are not used to offer that easiness to the passenger.

The present invention was developed in view of the said above opportunity, which is a luggage Trolley to be used in airports once they always circulate together with the passenger during his staying at airports, offering a new service under passenger's own responsibility, making possible to him several tasks through the use of a personal computer built-in the Trolley where his luggage is, as for instance: internet accesses, to type documents, recordings, watch a movie, hear music, and finally to use all of the resources offered by a micro computer. The invention to be better understood will be described and in consonance with the drawings where:

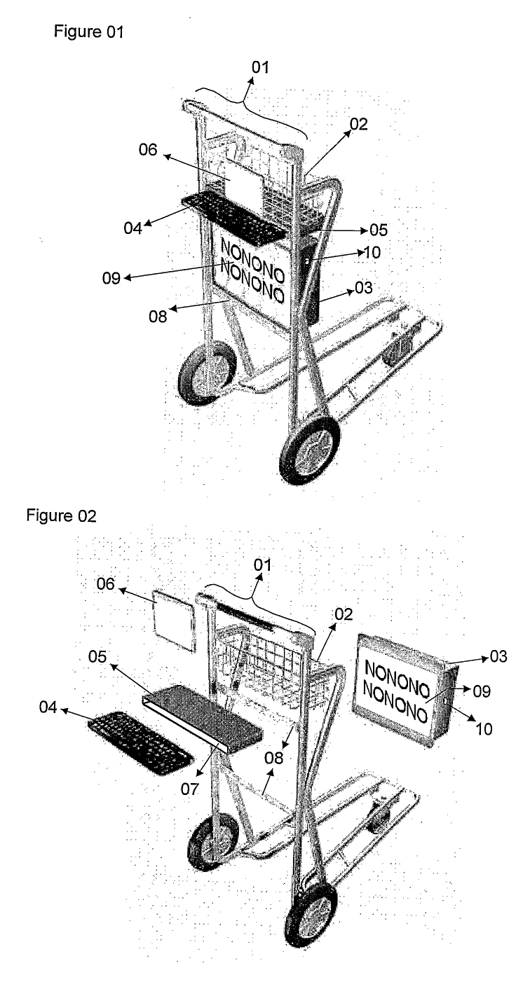

The FIG. 1 displays an airport Trolley from a back perspective in way that the keyboard and monitor can be visualized.

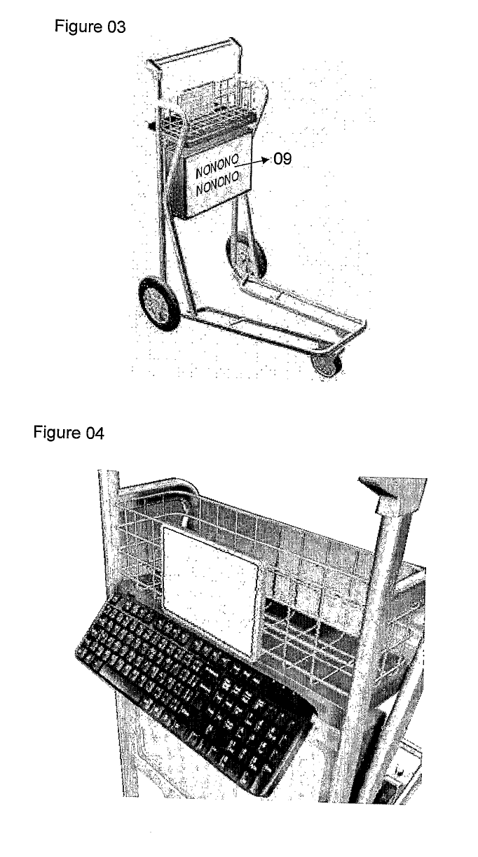

The FIG. 2 shows the same as of FIG. 1 however with the devices in an exploded view in way one can understand the disposition and assembly of the referred invention. The FIG. 3 displays the airport luggage Trolley in a diagonal front view and properly assembled.

The FIG. 4 shows an enlargement of the folding keyboard and monitor, properly installed on the airport luggage Trolley.

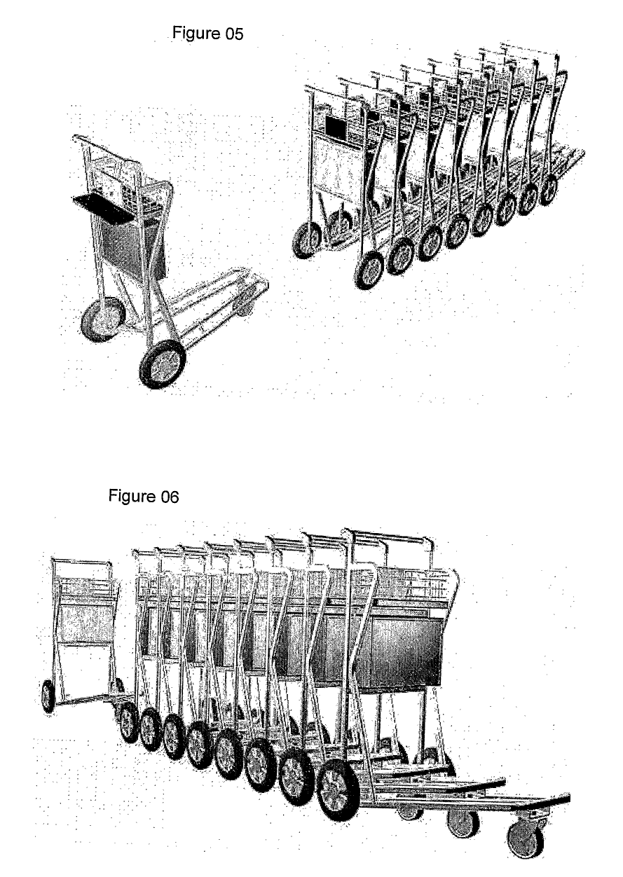

The FIG. 5 displays the disposition from a back perspective of airport luggage Trolleys in line and a separate Trolley show how they will be stored.

The FIG. 6 shows the same disposition of FIG. 5, however from a front view perspective.

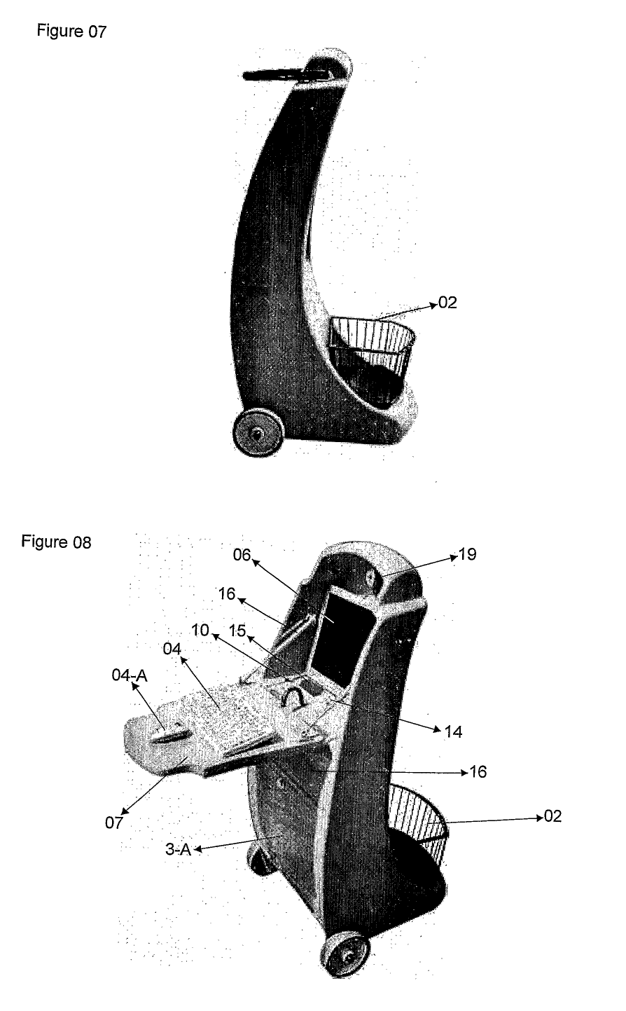

The FIG. 7 shows a lateral view of the pushcart of Figures from 1 to 6, however with an external compartment where will be kept all the internet components of the luggage Trolley presented in the Figures from 1 to 6.

The FIG. 8 shows in perspective like the FIG. 7 but from a different angle making able the interior visualization of the superior part of the described luggage Trolley.

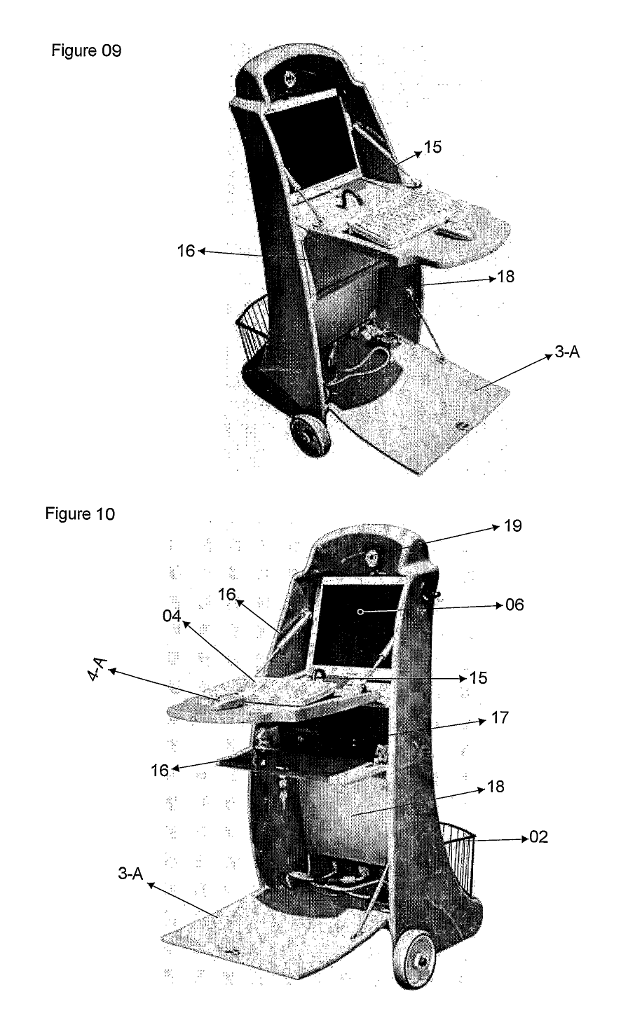

The FIG. 9 shows in a perspective view from a different angle and the second cover opened, but of the inferior part making possible the visualization of this internal part.

The FIG. 10 shows the same view of the FIG. 7, however with all the doors opened, making possible to understand the complete storage way of the components and internet access.

In accordance with the shown in the related Figures above, we have that: in the airport luggage Trolley (01) will be built sustentation bars (08) or internal compartments protected by the Covers (3-A, 07 and 16) and from the sustentation bar (08) will be built an inferior Compartment (03) where will be installed computer CPU (18) and its battery, that will have a minimum of two hours autonomy and in the arrangement shown in Figures from 7 to 10 the computer (18) will installed in the inferior compartment protected by the inferior Cover (3-A) and the batteries inside of the intermediate compartment (17) with Cover (16).

The same way for the arrangement shown in Figures from 1 to 6, in the inferior part of the luggage Basket (02) a superior Compartment will be installed (05) that will receive a Keyboard (04) and in the back part of the said luggage Basket (02) a Monitor will be installed (06) of liquid crystal type or similar, while in the arrangement shown in the Figures from 7 to 10 the referred Monitor (06) will be installed inside of a superior compartment protected by the superior Cover (07) that will also be responsible to sustain the Keyboard (04) and the Mouse (4-A), being its opening and closing facilitated by the use of Shock absorbers (16).

As can be noticed by the Figures, the inferior Compartment (03) makes available spaces, in its back and front parts, that can be use for advertising, in other words, Propagandas (09) besides that this inferior Compartment (03) will also have at least one female connector (10) for connection of cell phones chargers that in the arrangement of the Figures from 7 to 10 will be inside the superior compartment protected by the superior Cover (07), so that this female connector (10) it will be fed by the Battery of the Computer (18) or even by a second battery placed in the intermediate compartment (17) with Cover (16).

As it is noticed in the present introduction of the airport Trolley, we have that the inferior Compartment (03) will be built on the structure of the luggage Trolley (01) through the sustentation Bar (08) that will sustain the inferior Compartment (03) that will have Cabinet function for all the necessary components for the use of the micro Computer (18), as for instance, the wireless data transmission devices, diskettes or disk recording drivers, and also the battery to supply the Computer, in a way that these equipments will be interlinked to the folding Keyboard (04) and the Monitor (06) through cables for this purpose.

As already explained in the disposition of Figures from 7 to 10 the micro Computer (18) will also be placed internally in the inferior compartment protected by the inferior Cover (3-A) and it will have all the wireless data transmission devices, or similar, the diskettes or disk recording Drivers, USB input door (14) making possible a fast and easy use, or else, games devices for entertainment as Playstation or similar, included Webcam (19) or similar, as well as a Reading device (15) for payment through credit or pre-paid cards, and the battery will be placed in the intermediate compartment (17) or more than one unit for longer autonomy.

The FIG. 4 shows a enlarged folding keyboard (04) that will allow the user choose the best angle for the referred Keyboard (04) with built in mouse while in the FIG. 8 it is possible the keyboard be installed on the superior Cover (07) and a Mouse set (4-A) off the keyboard to be easy to worked, being this referred mouse of the Scrollbar type or similar and that for safety will also be fastened to the said superior Cover (07) so that the user can be comfortably seated and at the same time use the available services on the Computer through the keyboard that will have, besides the built-in mouse like the ones in notebooks or a separate Mouse (4-A) and still recharge the battery of a cell Phone through the female connector (10) installed on the lateral of the inferior Compartment (03) or internally to the superior compartment.

As seen, the present in the Figures from 1 to 6 the “AIRPORT LUGGAGE TROLLEY WITH A BUILT-IN PERSONAL COMPUTER” although shown in two visual configuration assemblies, the assembly disposition presented in the Figures from 1 to 6, is the simplified assembly on actual airport luggage Trolleys in a conceived way to be used by the general public inside airports in check-in rooms, where passengers usually carriers a larger luggage, and in the dispositions presented in the Figures from 7 to 10 shows the same equipment, for the same use and functionality, to be used in the departure gate rooms where only hand luggage are admitted, reason way the luggage Basket (02) was transferred for the front inferior part of the new assembly disposition.

It is known that practically all airplane passengers need Trolleys to carry their luggage, even hand luggage, and this way the passengers can enjoy in case they want or need a Trolley with a built-in Computer he can rent by means of a security deposit a trolley for the needed time and inside airport predetermined premises.

1) “AIRPORT LUGGAGE TROLLEY WITH A BUILT-IN PERSONAL COMPUTER” characterized by being an airport luggage Trolley (01) with a built-in personal Computer protected inside an inferior Compartment or inferior Covers (03) internally installed or through sustentation Bar (08) and interlinked to a Monitor (06) and a Keyboard (04).

2) “AIRPORT LUGGAGE TROLLEY WITH A BUILT-IN PERSONAL COMPUTER” characterized by being besides claim 1 also for having installed in the back part of the luggage Basket (02) or on the superior Cover (07) a crystal liquid or similar Monitor (06) and in the inferior part of the said luggage basket (02) a superior Compartment (04) or on the said Cover (07) a Keyboard with mouse (04) or a separated mouse (4-A).

3) “AIRPORT LUGGAGE TROLLEY WITH A BUILT-IN PERSONAL COMPUTER” characterized by being besides the claims 1 and 2, also for containing spaces for advertising media (09) directly on the lateral of the inferior Compartment (03) or on the external walls of the Trolley as shown in the Figures from 7 to 10.

4) “AIRPORT LUGGAGE TROLLEY WITH A BUILT-IN PERSONAL COMPUTER” characterized by being besides claims 1, 2 and 3, also for containing in the inferior Compartment (03) or inside the superior Cover (07) of the personal computer, at least a female connector (10) for cell Phones recharging, personal Cameras (19) of Web Cam type or similar and USB connection (14).
